(19) United States
(12) Patent Application Publication
(10) Pub. No.: US 2008/0123959 A1
(43) Pub. Date: May 29, 2008

(54) Computer-implemented method for automated object recognition and classification in scenes using segment-based object extraction

(76) Inventors: Edward R. Ratner, Los Altos, CA (US); Schuyler A. Cullen, Mt. View, CA (US)

Correspondence Address: OKAMOTO & BENEDICTO, LLP, P.O. BOX 641330, SAN JOSE, CA, 95164, US

(21) Appl. No.: 11/821,767

(22) Filed: Jun. 25, 2007

Related U.S. Application Data
(60) Provisional application No. 60/805,799, filed on Jun. 26, 2006.

(51) Int. Cl. G06K 9/34

(52) U.S. Cl. 382/173

(57) ABSTRACT

One embodiment relates to a computer-implemented method for automated object recognition and classification in scenes using segment-based object extraction. The method includes automated procedures for receiving video images, creating segmentation maps from said images, grouping segments so as to form extracted objects, extracting features from said extracted objects, classifying said extracted objects using said features. Other features, aspects and embodiments are also disclosed.

### CROSS-REFERENCE TO RELATED APPLICATIONS

The present application claims the benefit of U.S. Provisional Patent Application No. 60/805,799 filed Jun. 26, 2006, by inventors Edward Ratner and Schuyler A. Cullen, the disclosure of which is hereby incorporated by reference.

### BACKGROUND

1. Field of the Invention

The present application relates generally to digital video processing and more particularly to the automated recognition and classification of objects in images and video.

2. Description of the Background Art

Image segmentation generally concerns selection and/or separation of an object or other selected part of an image dataset. The dataset is in general a multi-dimensional dataset that assigns data values to positions in a multi-dimensional geometrical space. In particular, the data values may be pixel values, such as brightness values, grey values or color values, assigned to positions in a two-dimensional plane.

It is highly desirable to improve image segmentation techniques and applications of image segmentation. In this regard, the present application discloses a novel and advantageous technique for object recognition and classification in scenes using segment-based object extraction.

### BRIEF DESCRIPTION OF THE DRAWINGS

FIG. 1 is a flowchart of a method for object recognition and classification in scenes using segment-based object extraction in accordance with an embodiment of the invention.

FIG. 2 is a flowchart of a method of object extraction in accordance with an embodiment of the invention.

FIG. 3A depicts a sequence of raw video images in accordance with an embodiment of the invention.

FIG. 3B depicts a sequence of segmentation maps in accordance with an embodiment of the invention.

FIG. 3C depicts a sequence of segment groups in accordance with an embodiment of the invention.

FIG. 4 depicts a method of feature extraction, including keypoint selection, in accordance with an embodiment of the invention.

FIG. 5A depicts an original image in accordance with an embodiment of the invention.

FIG. 5B depicts a moving object extracted from the original image in accordance with an embodiment of the invention.

FIG. 5C depicts keypoints selected in accordance with an embodiment of the invention.

FIG. 6 depicts a flowchart of a method of classification in accordance with an embodiment of the invention.

FIG. 7 is a schematic diagram of an example computer system or apparatus which may be used to execute the computer-implemented procedures in accordance with an embodiment of the invention

### DETAILED DESCRIPTION

The present application discloses a computer-implemented method for automated object recognition and classification. In the following description, for purposes of explanation, specific nomenclature is set forth to provide a thorough understanding of the various inventive concepts disclosed herein. However, it will be apparent to one skilled in the art that these specific details are not required in order to practice the various inventive concepts disclosed herein.

The present disclosure also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories, random access memories, EPROMs, EEPROMs, magnetic or optical cards, or any type of media suitable for storing electronic instructions, and each coupled to a computer system bus or other data communications system.

The methods presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present disclosure is not described with reference to any particular programming language. It will be appreciated that a variety of programming languages may be used to implement the teachings of the invention as described herein.

Video has become ubiquitous on the Web. Millions of people watch video clips everyday. The content varies from short amateur video clips about 20 to 30 seconds in length to premium content that can be as long as several hours. With broadband infrastructure becoming well established, video viewing over the Internet will increase.

However, unlike the hyperlinked static Web pages that a user can interact with—video watching on the Internet is, today, a passive activity. Viewers still watch video streams from beginning to end much like they do with television. With static Web pages, on the other hand, users often search for text of interest to them and then go directly to that Web page. In direct analogy, it would be highly desirable, given an image or a set of images of an object, for users to be able to search for that object in a single video stream or in a collection of video streams.

A number of classifiers have now been developed that allow an object under examination to be compared with an object of interest or a class of interest. Some examples of classifier algorithms are Support Vector Machines (SVM), nearest-neighbor (NN) and Scale Invariant Feature Transforms (SIFT). The classifier algorithms are applied to the subject image. They compute some properties of the image, which are then compared to the properties of the object/objects of interest. If the properties are close in some metric, then the classifier produces a match.

One of the serious limitations of current classifiers is the so-called Clutter Problem. The Clutter Problem refers to the situation where multiple overlapping objects are present in the image frame under examination. Since the classifier algorithms have no a priory knowledge of the object locations, they end up computing properties of various image regions. These image regions will, in general, contain portions of other objects. Hence, the classifier signal becomes contaminated and fails to produce good matches.

The present application discloses a new process to robustly perform object identification/classification in complex scenes that contain multiple objects. Advantageously, the process largely overcomes some of the limitations and problems of current classifiers, including the above-described Clutter Problem.

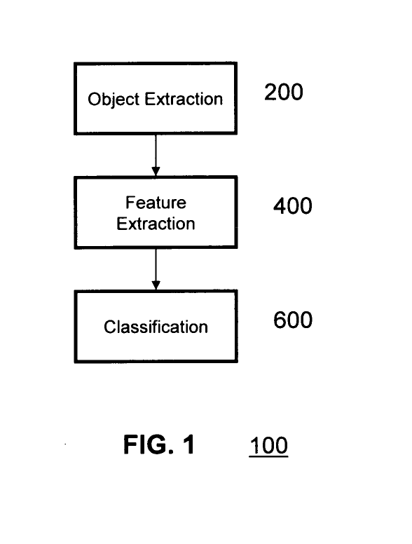

FIG. 1 is a flowchart of a method 100 for object recognition and classification in scenes using segment-based object extraction in accordance with an embodiment of the invention. As shown, the method includes steps of object extraction 200, feature extraction 400, and classification 600.

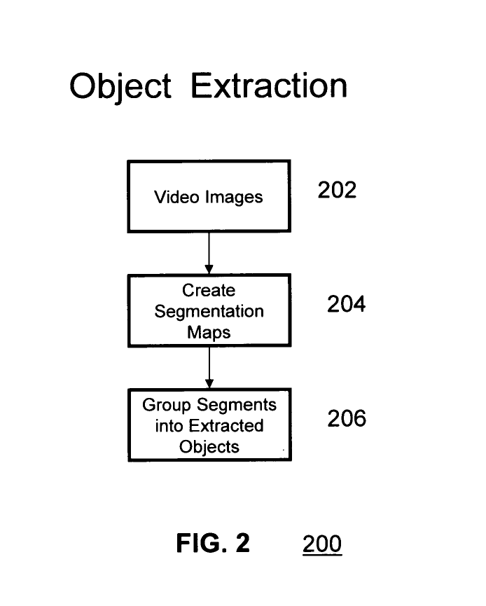

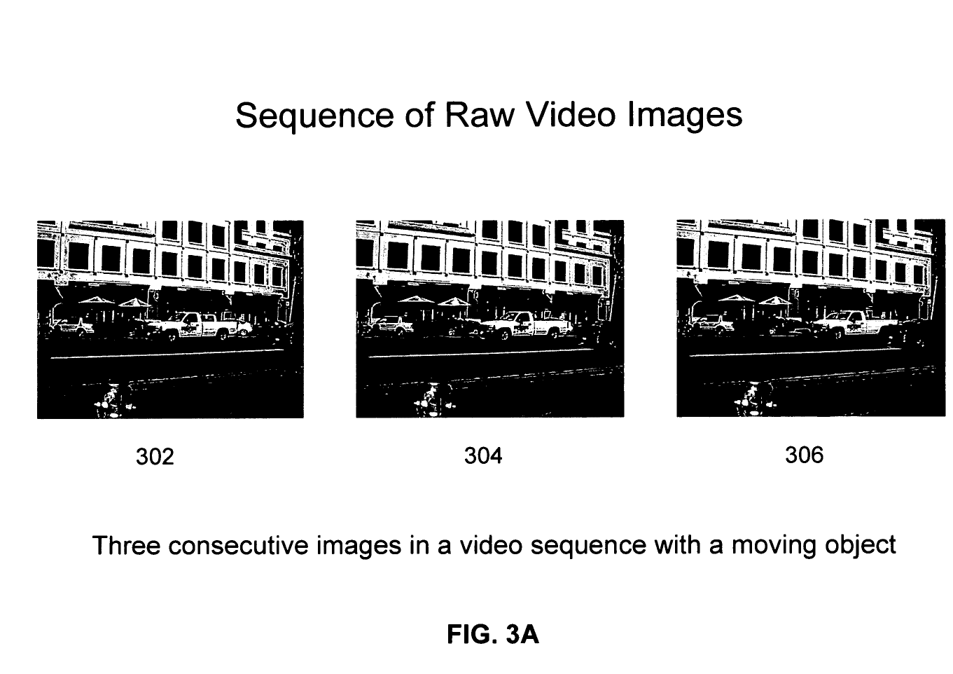

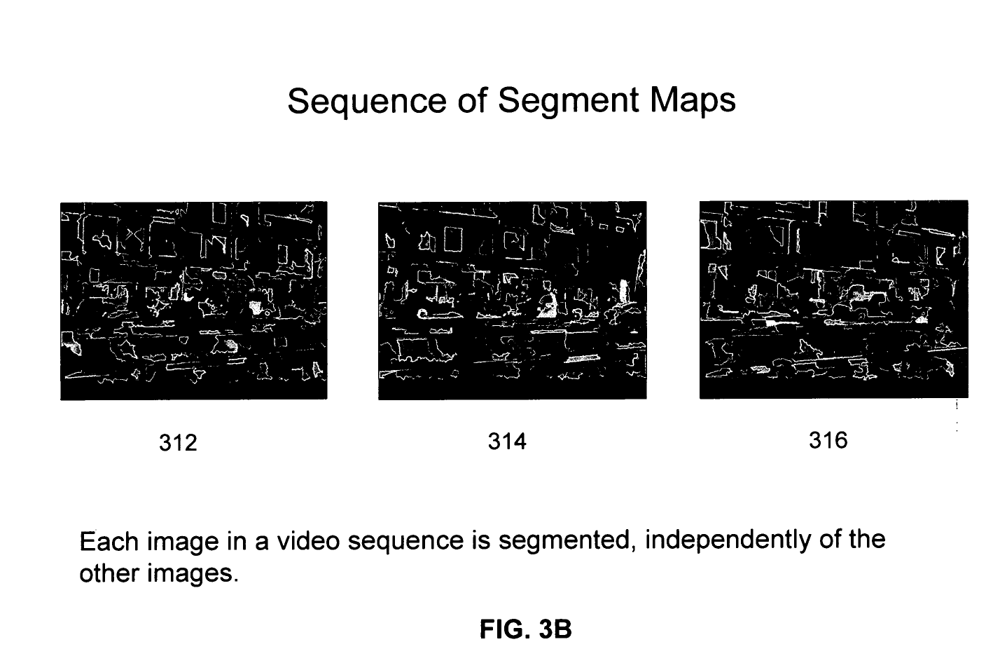

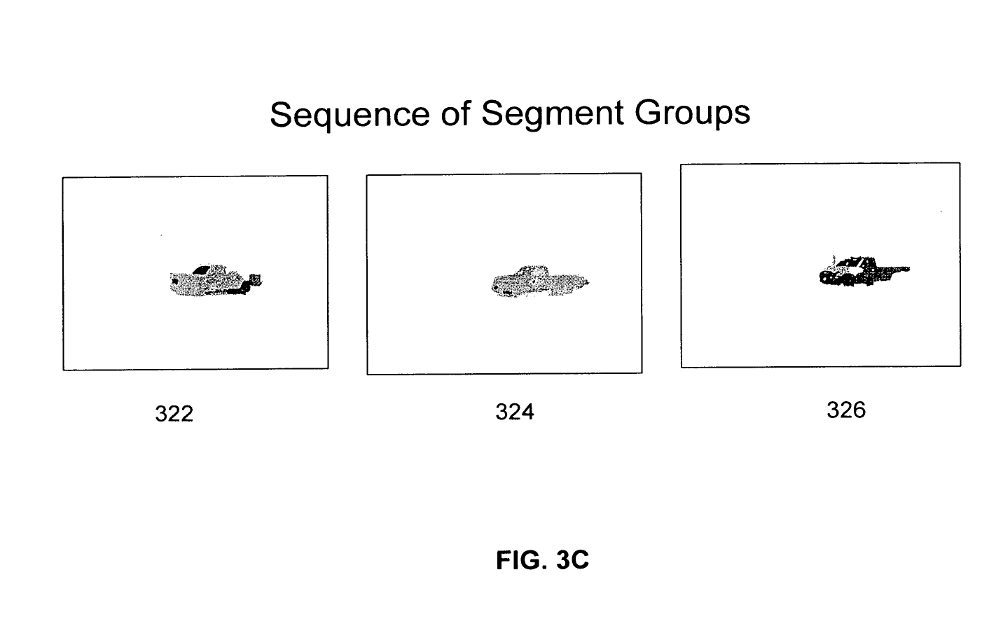

FIG. 2 is a flowchart of a method 200 of object extraction in accordance with an embodiment of the invention. In a first block 202, video images are received. An example sequence of raw video images is shown in FIG. 3A. In particular, the sequence includes three sequential images 302, 304, and 306.

In a second block 204, segmentation maps are created from the raw video images. In other words, given static image is segmented to create image segments. Each segment in the image is a region of pixels that share similar characteristics of color, texture, and possible other features. Segmentation methods include the watershed method, histogram grouping and edge detection in combination with techniques to form closed contours from the edges. For example, a sequence of segmentation maps (312, 314, and 316) is shown in FIG. 3B, where the sequence of segmentation maps of FIG. 3B correspond to the sequence of raw video images of FIG. 3A.

In a third block 206, the segments are grouped into extracted objects. For example, a grouping of segments corresponding to a moving object is shown in the sequence of images 322, 324, and 326 depicted in FIG. 3C. Segments maybe grouped into objects by considering their motion vectors, colors, textures or other attributes.

Although other embodiments are contemplated, a first technique to perform segment grouping is as follows.
a. A given static image is segmented to create image segments. Each segment in the image is a region of pixels that share similar characteristics of color, texture, and possible other features. Segmentation methods include the watershed method, histogram grouping and edge detection in combination with techniques to form closed contours from the edges.
b. Given a segmentation of a static image. The motion vectors for each segment are computed. The motion vectors are computed with respect to displacement in a future frame/frames or past frame/frames. The displacement is computed by minimizing an error metric with respect to the displacement of the current frame segment onto the target frame. One example of an error metric is the sum of absolute differences. Thus, one example of computing a motion vector for a segment would be to minimize the sum of absolute difference of each pixel of the segment with respect to pixels of the target frame as a function of the segment displacement.
c. Links between segments in two frames are created. A segment (A) in frame 1 is linked to a segment (B) in frame 2 if segment A, when motion compensated by its motion vector, overlaps with segment B. The strength of the link is given by some combination of properties of Segment A and Segment B. For instance, the amount of overlap between motion-compensated Segment A and Segment B. Alternatively, the overlap of the motion-compensated segment B and segment A could be used. Or a combination of the two.
d. A temporal graph is constructed for N frames, where:
   i. Each segment forms a node in the graph.
   ii. Each link discussed above forms a weighted edge between the corresponding nodes.
e. Once the graph is constructed, it is partitioned using an algorithm that minimizes a connectivity metric. A connectivity metric of a graph may be defined as the sum of all edges in a graph. A number of methods are available for minimizing a connectivity metric on a graph for partitioning, such as the “min cut” method.
f. The partitioning is applied to each sub-graph obtained in step e.
g. The process is repeated until each sub-graph meets some predefined minimal connectivity criterion or satisfies some other statically defined criterion, when the process stops.

A second (alternate) technique to perform segment grouping is discussed below.
a. A given static image is segmented to create image segments. Each segment in the image is a region of pixels that share similar characteristics of color, texture, and possible other features. Some examples of segmentation methods are the watershed algorithm, histogram grouping and edge detection in combination with techniques to form closed contours from the edges.
b. Given a segmentation of a static image, the motion vectors for each segment are computed. The motion vectors are computed with respect to displacement in a future frame/frames or past frame/frames. The displacement is computed by minimizing an error metric with respect to the displacement of the current frame segment onto the target frame. One example of an error metric is the sum of absolute differences. Thus, one example of computing a motion vector for a segment would be to minimize the sum of absolute differences for the pixels of the segment with respect to pixels of the target frame as a function of the segment displacement. In general, several motion vectors for each segment are computed (i.e. previous frame, next frame, and so on).
c. Some static properties of each segment on the current frame are computed. Some examples are average color, color histograms, and texture metrics such as standard deviation of the color in the segment from the segment average.
d. Each segment is assigned a descriptor vector where each entry in the vector corresponds to either a motion vector property described above in step b or a static color property described above in step c. An example of a descriptor vector is:
   (Xdisplacementnexframe, Ydisplacementnextframe, Xdisplacementprevioustframe, Ydisplacementpreviousframe, AverageRedcomponent, AverageGreencomponent, AverageBluecomponent)
e. For each pair of adjacent segments an error with respect to some metric is computed for their descriptor vectors. An example would be a sum of absolute differences on the components of the descriptor vectors.
f. If the error of a pair of segments is below some threshold value, the segments are grouped into a single object. The grouping is transitive, i.e if segment A is grouped with segment B and if segment B is grouped with segment C, then A, B and C form a single object group.

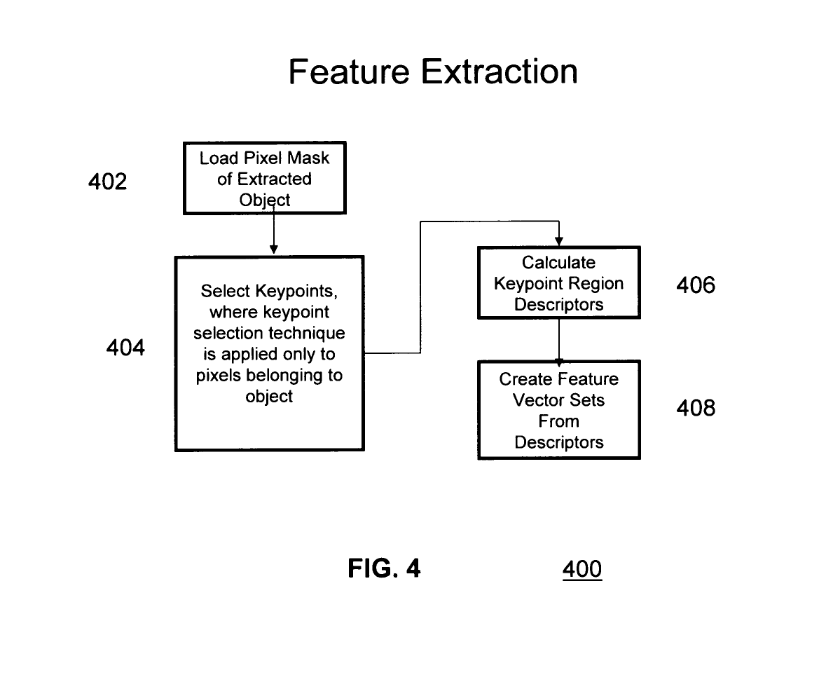

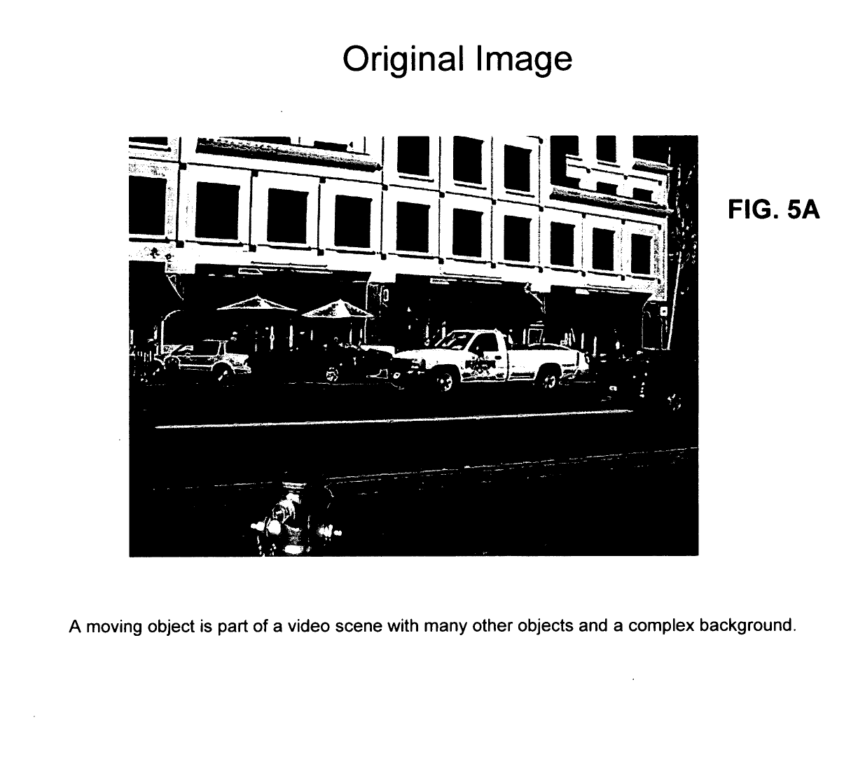

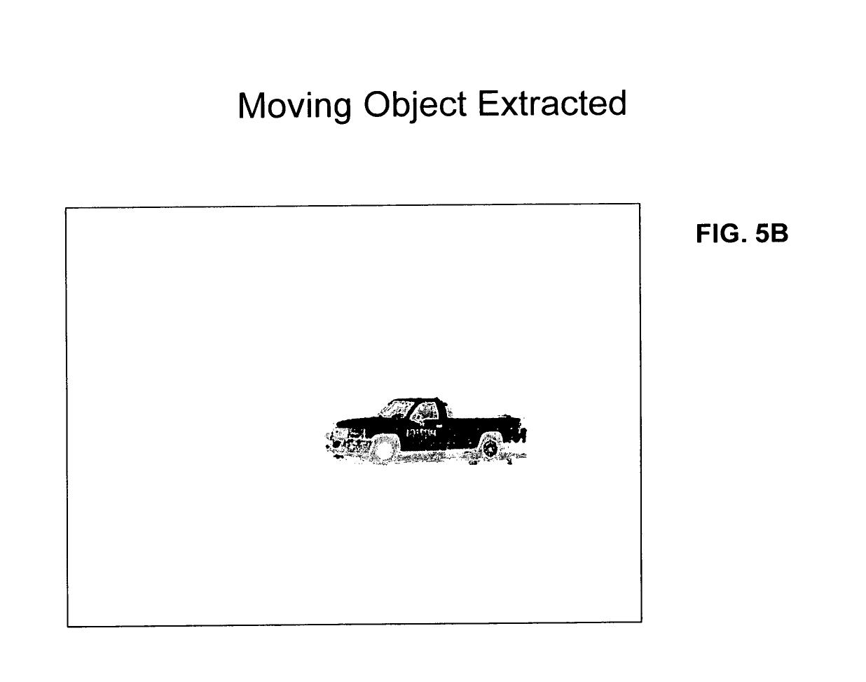

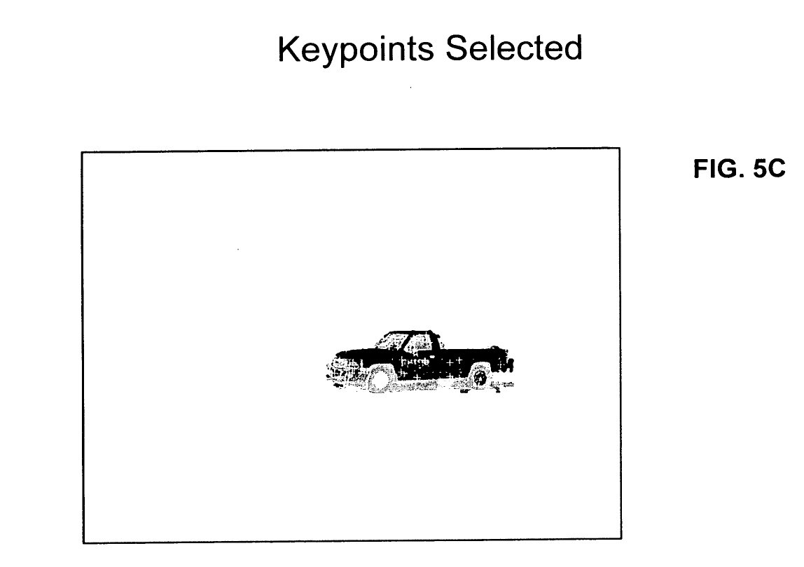

FIG. 4 depicts a method 400 of feature extraction, including keypoint selection, in accordance with an embodiment of the invention. In block 402, a pixel mask of an extracted object may be loaded so as to perform the feature extraction upon that object. For example, consider the original image shown in FIG. 5A. Here, an example moving object (i.e. the pickup truck) is part of a video scene with many other objects and a complex background. The example moving object (i.e. the pickup truck) as extracted from that original image is shown in FIG. 5B. As discussed above, the object may be extracted from the rest of the video content using segmentation and temporal segment grouping techniques over a number of frames.

Per block 404, keypoints are selected. Here, because the feature extraction is being performed on an extracted object, the keypoint selection technique is applied only to pixels belonging to the object. Advantageously, since the object has been extracted from its environment, its neighbors do not contaminate the classifier signal. This subsequently results in significantly better performance during classification. For example, keypoints may be selected from the pixels of the extracted moving object shown in FIG. 5B. Such selected keypoints are shown, for example, in FIG. 5C. As seen in FIG. 5C, keypoints, depicted by “+” symbols, are only selected from the pixels belonging to the object. Thus, the Clutter Problem is removed or sidestepped, and highly accurate classification of the object is enabled.

In block 406, the keypoint region descriptors may then be calculated 406. Subsequently, feature vector sets may be created from the descriptors per block 408.

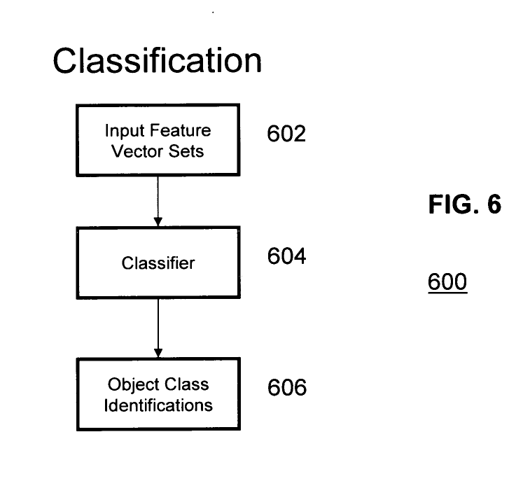

FIG. 6 depicts a flowchart of a method 600 of classification in accordance with an embodiment of the invention. In block 602, the feature vector sets are input. These feature vector sets are those derived from the keypoint region descriptors, as discussed above.

The classifier may then be applied to the feature vector sets per block 604. In one embodiment, the classifier may have been trained according to an object class taxonomy. Examples of classifiers include support vector machines, neural networks, and k-means trees.

When passed into the classifier, the feature vector sets are determined to belong to a particular object class. Object class identifications are thus generated per block 606.

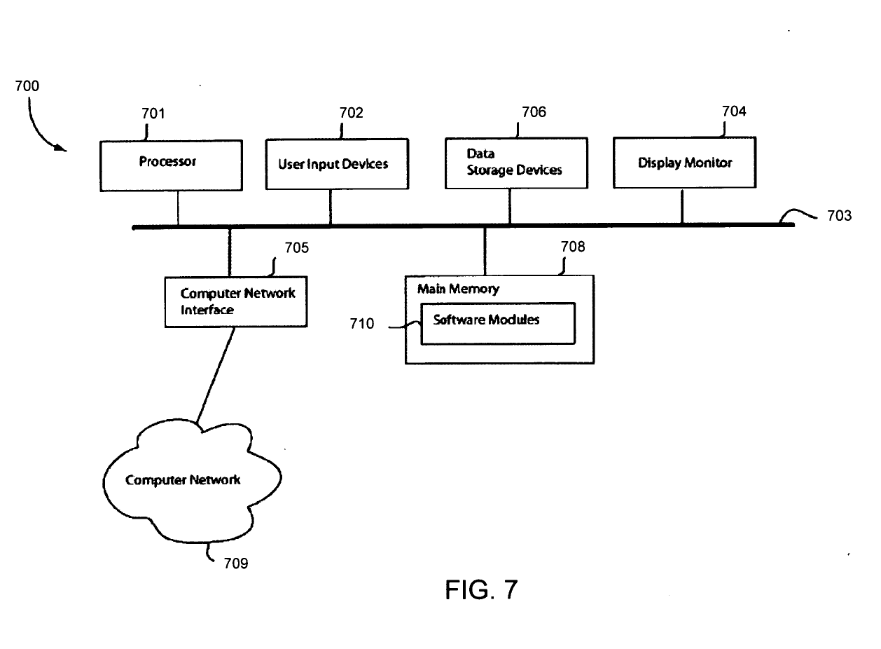

FIG. 7 is a schematic diagram of an example computer system or apparatus 700 which may be used to execute the computer-implemented procedures in accordance with an embodiment of the invention. The computer 700 may have less or more components than illustrated. The computer 700 may include a processor 701, such as those from the Intel Corporation or Advanced Micro Devices, for example. The computer 700 may have one or more buses 703 coupling its various components. The computer 700 may include one or more user input devices 702 (e.g., keyboard, mouse), one or more data storage devices 706 (e.g., hard drive, optical disk, USB memory), a display monitor 704 (e.g., LCD, flat panel monitor, CRT), a computer network interface 705 (e.g., network adapter, modem), and a main memory 708 (e.g., RAM).

In the example of FIG. 7, the main memory 708 includes software modules 710, which may be software components to perform the above-discussed computer-implemented procedures. The software modules 710 may be loaded from the data storage device 706 to the main memory 708 for execution by the processor 701. The computer network interface 705 may be coupled to a computer network 709, which in this example includes the Internet.

A method and system for object recognition and classification in scenes using segment-based object extraction have been described with respect to specific examples and subsystems. One particularly advantageous aspect of the technique disclosed herein is that by pre-extracting the objects before applying the classifier, the Clutter Problem may be eliminated or substantially reduced. This allows for effective object recognition and classification in realistic, complex video scenes.

In the above description, numerous specific details are given to provide a thorough understanding of embodiments of the invention. However, the above description of illustrated embodiments of the invention is not intended to be exhaustive or to limit the invention to the precise forms disclosed. One skilled in the relevant art will recognize that the invention can be practiced without one or more of the specific details, or with other methods, components, etc. In other instances, well-known structures or operations are not shown or described in detail to avoid obscuring aspects of the invention. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined by the following claims, which are to be construed in accordance with established doctrines of claim interpretation.

What is claimed is:

1. A computer-implemented method for automated image object recognition and classification, the method comprising:
receiving video images;
creating segmentation maps from said images;
grouping segments so as to form extracted objects;
extracting features from said extracted objects; and
classifying said extracted objects using the features.

2. The method of claim 1, wherein extracting features from an extracted object comprises:
loading a pixel mask of the extracted object; and
selecting keypoints using a keypoint selection technique which is applied only to pixels belonging to the extracted object.

3. The method of claim 2, wherein extracting features from the extracted object further comprises:
calculating keypoint region descriptors; and
creating feature vector sets from said descriptors.

4. The method of claim 1, wherein classifying said extracted objects comprises:
inputting said feature vector sets; and
applying a classifier to said feature vector sets which identifies object classes based on said feature vector sets.

5. A computer apparatus configured for automated image object recognition and classification, the apparatus comprising:
a processor for executing computer-readable program code;
memory for storing in an accessible manner computer-readable data;
computer-readable program code configured to receive video images;
computer-readable program code configured to create segmentation maps from said images;
computer-readable program code configured to group segments so as to form extracted objects;
computer-readable program code configured to extract features from said extracted objects; and
computer-readable program code configured to classify said extracted objects using the features.

6. The apparatus of claim 5, wherein the computer-readable program code to extract features is further configured to load a pixel mask of the extracted object, and to select keypoints using a keypoint selection technique which is applied only to pixels belonging to the extracted object.

7. The apparatus of claim 6, wherein the computer-readable program code to extract features is further configured to calculate keypoint region descriptors, and to create feature vector sets from said descriptors.

8. The apparatus of claim 5, wherein the computer-readable program code to classify said extracted objects is further configured to input said feature vector sets and to apply a classifier to said feature vector sets which identifies object classes based on said feature vector sets.
